(19) United States
(12) Patent Application Publication
(10) Pub. No.: US 2003/0035482 A1
(43) Pub. Date: Feb. 20, 2003

(54) Image size extension

(76) Inventors: Michiel Adriaanszoon Klompenhouwer, Eindhoven (NL); Mark Jozef Willem Mertens, Eindhoven (NL); Frederik Jan De Bruijn, Eindhoven (NL); Robert Jan Schutten, Campbell, CA (US)

Correspondence Address: Michael E. Marion, c/o U.S. PHILIPS CORPORATION, Intellectual Property Department, 580 White Plains Road, Tarrytown, NY, 10591, US

(21) Appl. No.: 10/219,421

(22) Filed: Aug. 15, 2002

(30) Foreign Application Priority Data
Aug. 20, 2001 (EP) 01203148.0

(51) Int. Cl. H04N 7/00; H04N 11/02

(52) U.S. Cl. 375/240.16; 348/36; 382/284

(57) ABSTRACT

The image processing unit (200,201,203,205,207) comprises an extension unit (208) for extending a first image (110) at a side of the first image (110) with pixels of a second image (108) based on a second set of motion vectors (212). The image processing unit (200,201,203,205,207) further comprises a motion estimation unit (204) for estimating a first set of motion vectors (210) of pixels corresponding to a first portion (105) of a scene (100) which is visible in the first image (110) and a second image (108), and a motion extrapolation unit (206) for estimating the second set of motion vectors (212) of pixels corresponding to a second portion (103) of the scene (100) which is visible in the second image (108), but invisible in the first image (110), based on the first set of motion vectors (210).

The invention relates to a method and unit and to an image display apparatus comprising such a unit.

Several aspect ratios of television standards exist. Nowadays, the 16:9 widescreen aspect ratio is one of these. But still most TV-broadcasts are in 4:3 aspect ratio. Hence some form of aspect ratio conversion is necessary. Some common methods and their drawbacks for conversion from 4:3 to 16:9 are:

adding black bars at the sides. This gives no real 16:9 result;

stretching the image horizontally and vertically. This means that in many cases information at top and bottom is lost. However the approach is perfect when the 4:3 material is actually 16:9 with black bars at the top and bottom, which is called “letterbox” mode.

stretching only horizontally. The result is that all objects in the images are distorted.

U.S. Pat. No. 5,461,431 discloses that the images are stretched horizontally with a non-uniform zoom factor, which is called a “panoramic stretch”. The effect is that objects to the side are more distorted than in the center. The panoramic stretch is acceptable for still images, but in the case of a horizontal movement in the image, e.g. caused by camera panning, objects will be subjected to different zoom factors as they cross the screen. This can be quite annoying.

It is an object of the invention to provide an image processing resulting in relatively few distortions. To this end, the invention provides an image processing as defined by the independent claims. The dependent claims define advantageous embodiments.

To achieve an extended image with relatively few distortions or loss of portions of the first image, image information, i.e. pixels, should be added in some way to at least one of the sides of the first image. It is almost impossible to extract the extra information from the first image itself. However, in case of a pan or a zoom, this information can be found in previous or subsequent images. For example, if the camera capturing the scene pans right, the information beyond the left image border is present in the previous image, while the information beyond the right image border is present in the next image. The basic procedure is as follows: calculate motion vectors outside the first image based on motion vectors inside the first image and fetch pixels from the second image, i.e. a previous or a next image with these motion vectors.

In an embodiment of the image processing unit according to the invention, the extension unit is arranged to extend the first image similarly at another side of the first image with pixels of a third image. An important parameter is the number of pixels that can be added reliable to the first image. This number will very likely increase when pixels from both previous and next images can be added.

An embodiment of the image processing unit according to the invention further comprises a motion model unit for generating a motion model describing global changes between the first image and the second image, the motion model being based on the first set of motion vectors, and being input for the motion extrapolation unit. The motion model can comprise parameters related to global changes between the first image and the second image that are caused by panning of a camera capturing the scene or that are caused by changed zoom of the camera capturing the scene, e.g. pan speed, pan direction and zoom speed. The advantage of making a motion model is an increase of robustness of the method of extending the first image as performed by the image processing unit.

An embodiment of the image processing unit according to the invention further comprises an enlargement unit to enlarge the extended image to an enlarged image with a predefined aspect ratio. The first image is extended using pixels of a number of previous and next images. But no more pixels are added than can be done reliably, i.e. without creating visible or objectionable artifacts. If the pixels are added e.g. left and/or right of the first image, then the extended image will have a width between the first image and the desired image, i.e. the enlarged image. This extended image is stretched by the enlargement unit into the desired enlarged image. Any extensions of the first image in the extension unit will result in less stretching of the extended image in the enlargement unit, and therefore to less distortions. The advantage of the embodiment according to the invention is that transition between stretch at low pan speeds and extension with pixels at high pan speeds can be done in a gradual way.

In an embodiment of the image processing unit according to the invention comprising the enlargement unit, the enlargement unit is arranged to perform a non-uniform zoom. The advantage of a non-uniform zoom is that it allows to select regions in the images with less distortions caused by the inevitable zoom. Now the strengths and weaknesses of the extension unit and the enlargement unit combine to advantage.

In the case of a high pan speed, the non-uniform zoom will give a lower quality result because objects moving across the screen undergo different zoom factors: they change shape over time. However the extension unit will very likely be able to add more pixels from the surrounding images.

In the case of low pan speed the extension unit will not be able to add many pixels reliably, because the information is not present in the surrounding images, or the information is only found in images at a large time difference with the first image. This not only means that more memory is necessary, but more importantly, also the motion vectors are less accurate when extended over long time intervals. It might be that object motion between images at large time differences can not accurately be described by simply extending a motion vector from the first image. But, on the other hand, slow or non-moving objects can be transformed by the non-uniform zoom, because the annoying change of shape over time is not present. In the case of still images it might be that the extended image is equal to the first image: no extension at all.

In an embodiment of the image processing unit according to the invention comprising the enlargement unit, a first aspect ratio of the first image and the predefined aspect ratio of the enlarged image are substantially equal to values of elements of the set of standard aspect ratios being used in television. Possible values are e.g. 4:3; 16:9 and 14:9.

In an embodiment of the image processing unit according to the invention comprising the enlargement unit, the enlargement unit is arranged to set the center of the enlarged image substantially equal to the center of the first image. The pixel extension can be performed asymmetrically by adding more pixels at one side than at the other. This could cause the center of the enlarged image to move out of the center of the first image, if the enlargement unit was not aware of this. Therefore it is preferred that the enlargement unit takes this asymmetry into account, e.g. by performing an asymmetric non-uniform zoom.

Another embodiment of the image processing unit according to the invention comprises a reliability unit to control the extension unit based on a reliability of the first set of motion vectors. The extension unit has to add as many pixels as possible without generating annoying artifacts. How many and what kind of artifacts can be tolerated is mainly a subjective issue, but some general principles can be identified. There are some criteria that indicate the reliability, to control the number of pixels to be added:

The further away in time to get information, the less reliable it will be. Therefore, the higher the pan speed, the more extra information will be available in images at small time intervals and the more information can be added reliably. Furthermore, the number of previous and/or next images in memory will be limited. So this by itself will pose a limitation on the number of pixels that can be retrieved.

If there is motion in two directions which are perpendicular to each other, then some pixels for the extensions are missing. E.g. if there is not only horizontal motion, but also vertical motion caused by a diagonal pan or pan and zoom at the same time, the top or bottom part of a side panel will not be available. Operations as e.g. mirroring or repeating pixel values beyond borders to “create” pixel values outside the image may be tolerable. In the case of horizontal extension, the amount of vertical motion will likely be a limiting factor. Therefore, the horizontal and vertical pan and/or zoom speeds at both image sides will give some indication of the reliability that can be expected. The first set of motion vectors provides information to determine the reliability. Alternatively or in addition thereto, the match errors obtained during the motion estimation can be used as information as to the reliability of the motion vectors.

In another embodiment of the image processing unit according to the invention, the extension unit is arranged to extend the first image with pixels of a fourth image which is also extended in a similar way. To overcome problems with limited memory and motion vectors that are extended beyond their validity, a recursive approach is used.

Modifications of the image processing unit and variations thereof may correspond to modifications and variations thereof of the method and of the image display apparatus described.

These and other aspects of the image processing unit, of the method and of the image display apparatus according to the invention will become apparent from and will be elucidated with respect to the implementations and embodiments described hereinafter and with reference to the accompanying drawings, wherein:

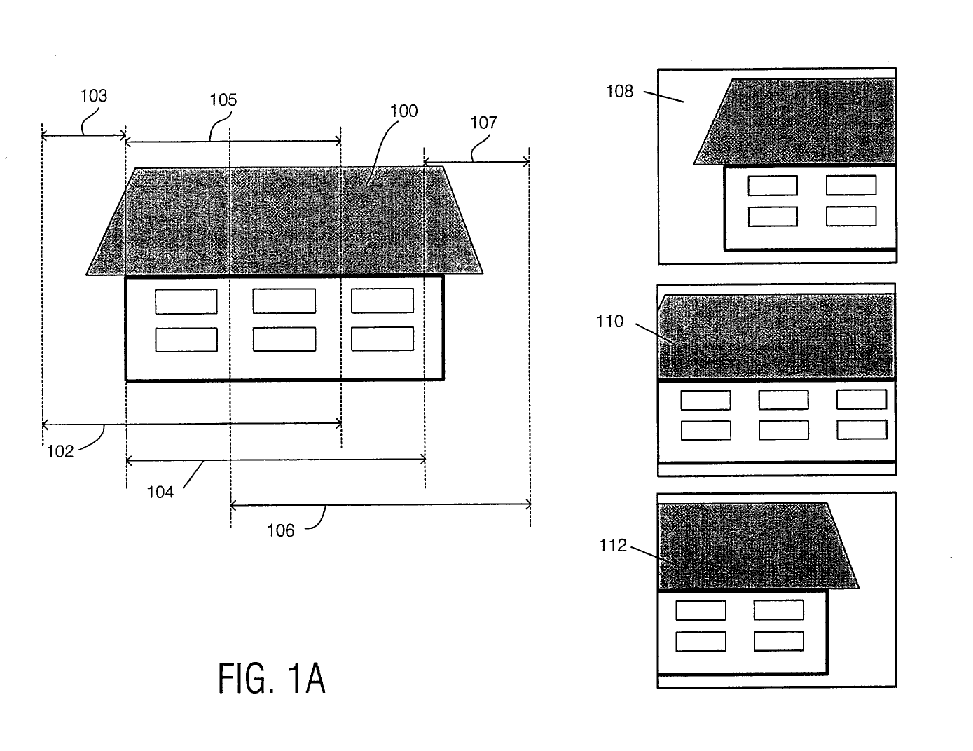

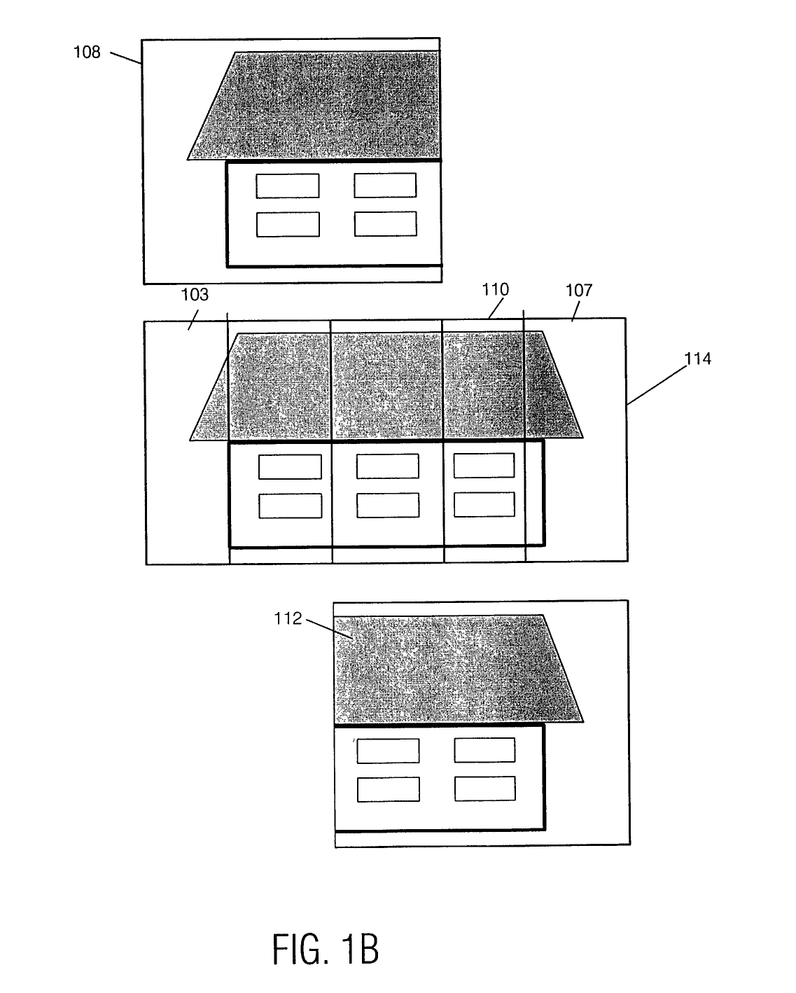

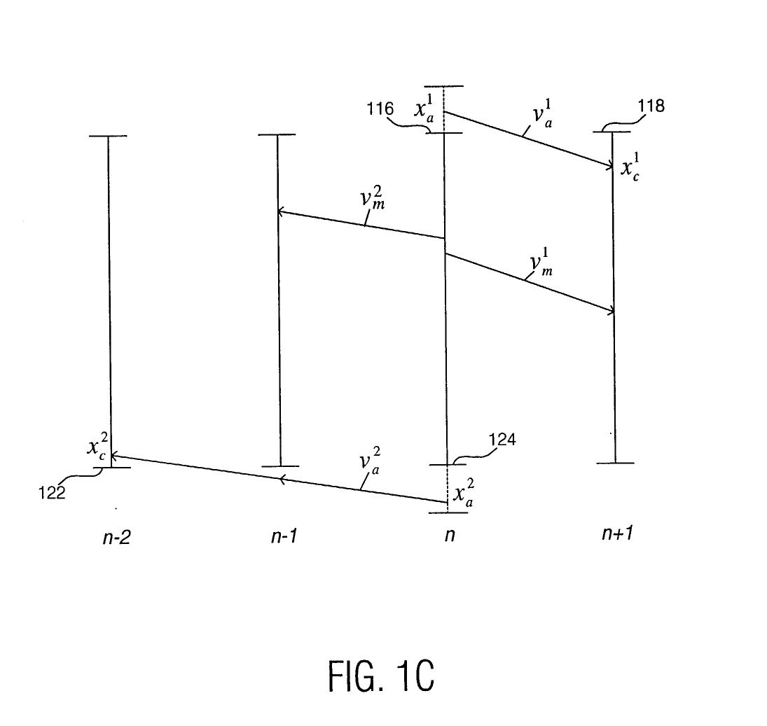

FIG. 1A schematically shows 3 images of a scene captured by a camera that was panning in a horizontal direction;

FIG. 1B schematically shows an extended image made of three images of a sequence;

FIG. 1C schematically shows the extension of an image n using motion vectors and surrounding images;

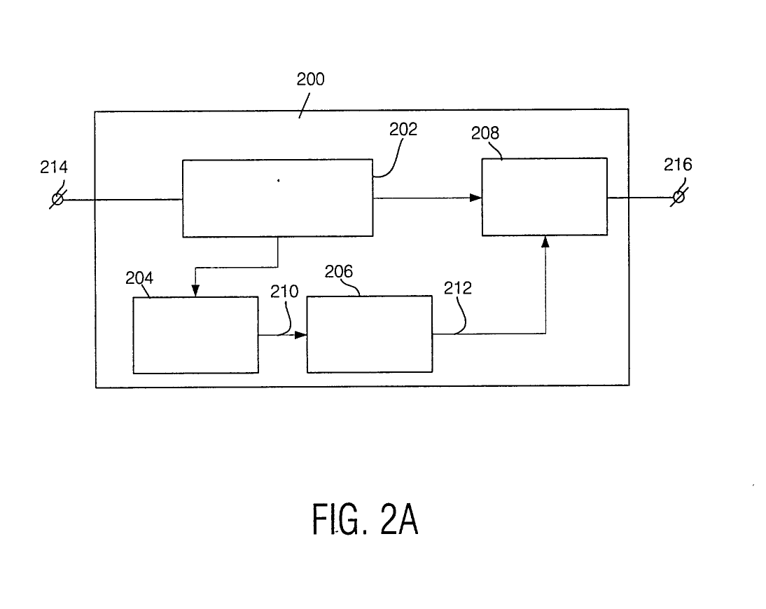

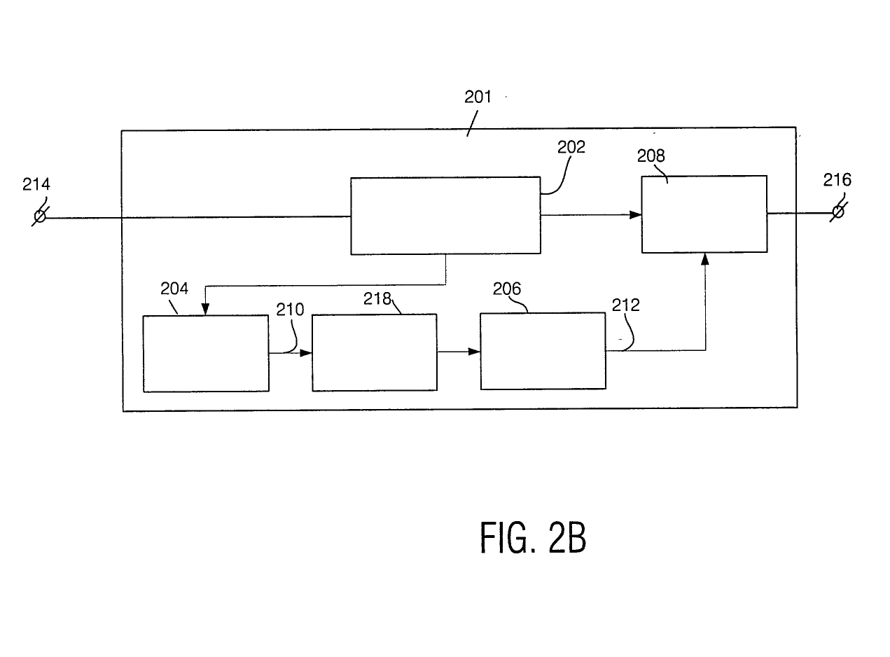

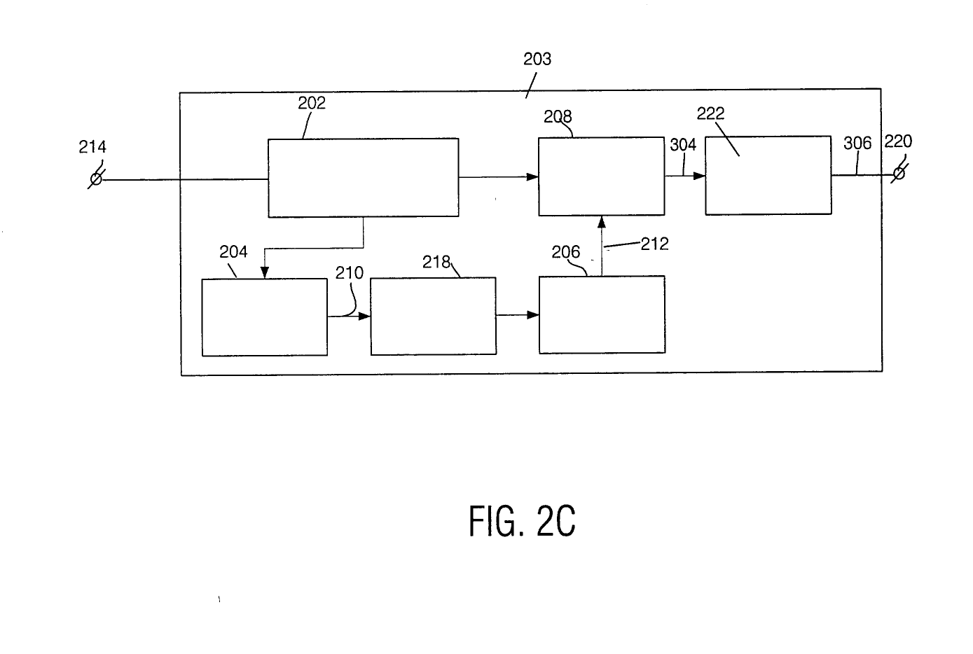

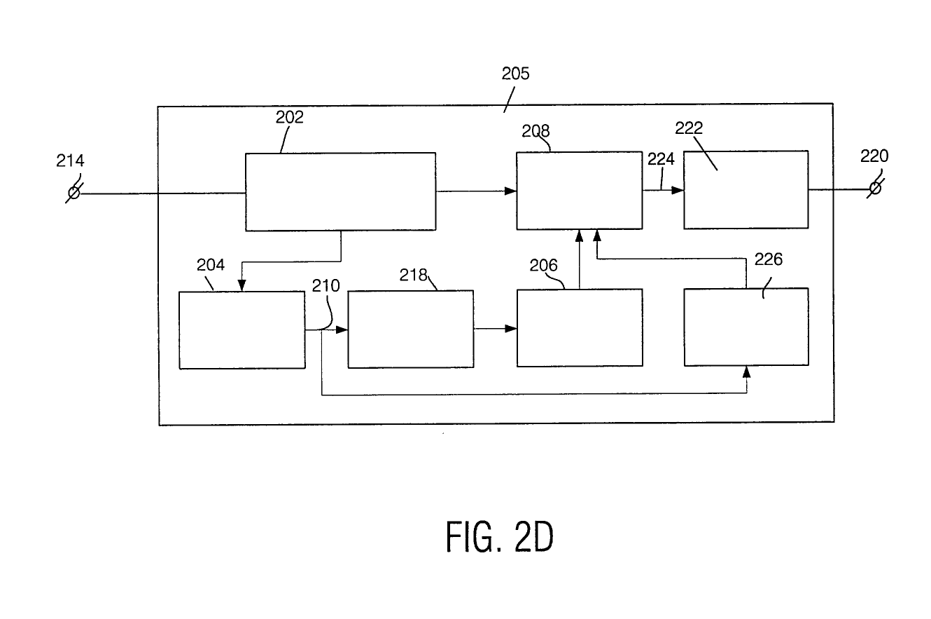

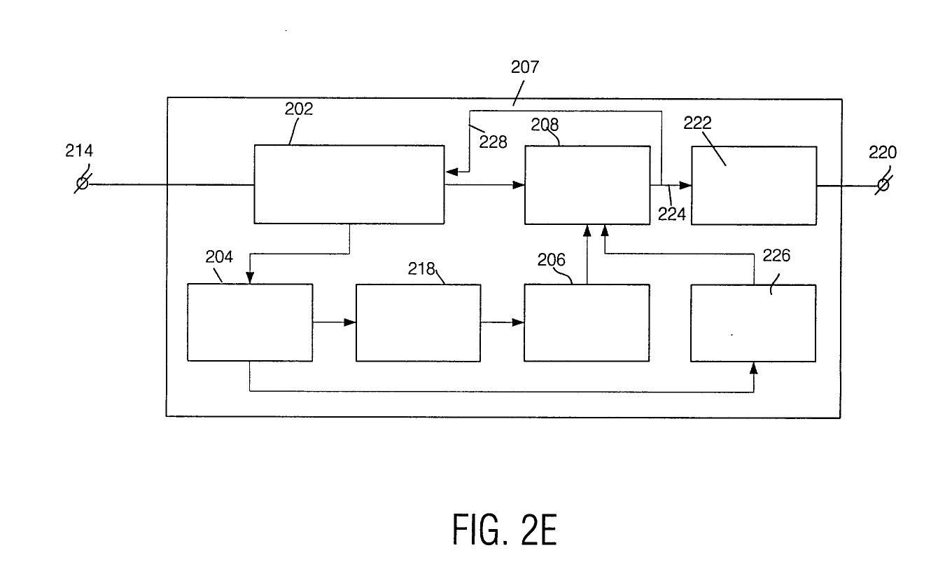

FIG. 2A schematically shows an embodiment of an image processing unit according to the invention;

FIG. 2B schematically shows an embodiment of an image processing unit according to the invention comprising a motion model unit;

FIG. 2C schematically shows an embodiment of an image processing unit according to the invention comprising an enlargement unit;

FIG. 2D schematically shows an embodiment of an image processing unit according to the invention comprising a reliability unit;

FIG. 2E schematically shows an embodiment of an image processing unit according to the invention being arranged to extend images recursively;

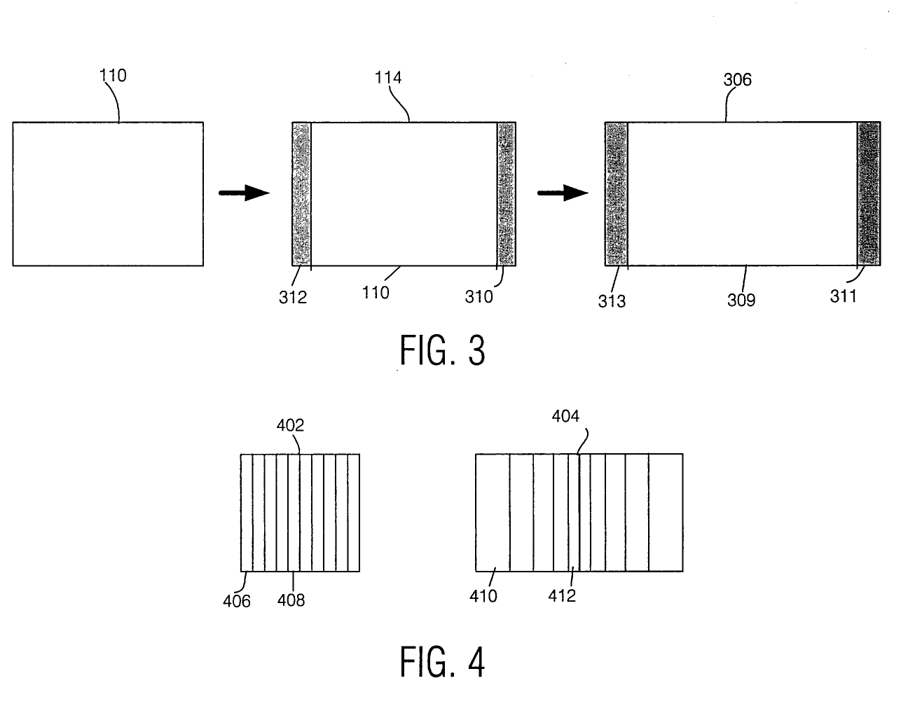

FIG. 3 schematically shows a first image, an extended image and an enlarged image;

FIG. 4 schematically shows the effect of a non-uniform zoom; and

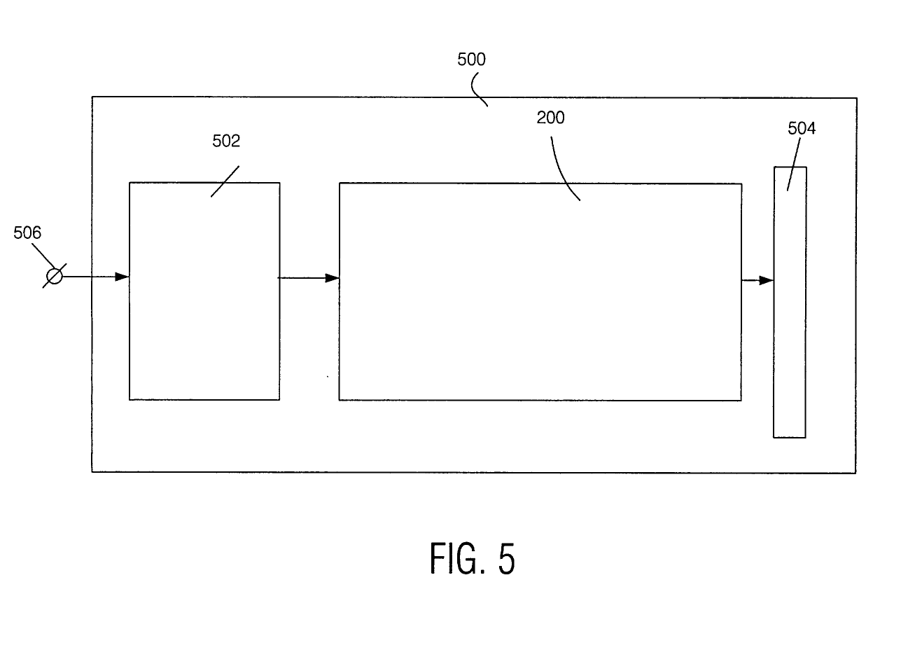

FIG. 5 schematically shows an image display apparatus according to the invention.

Corresponding reference numerals have the same meaning in all of the Figs.

FIG. 1A schematically shows 3 images 108-112 of a scene 100 captured by a camera that was panning in a horizontal direction. Image 108 comprises the left portion 102 of the scene 100. Image 110 comprises the middle portion 104 of the scene 100. Image 112 comprises the right portion 106 of the scene 100. The portion 103 is visible in image 108 but is invisible in image 110. The portion 105 is both visible in image 108 an image 110. The portion 107 is visible in image 112 but is invisible in image 110.

FIG. 1B schematically shows an extended image 114 made of three images 108-112 of a sequence. The extended image 114 is created by extending image 110 with the portion 103 of the scene 100 by extracting pixels from image 108 and with the portion 107 of the scene 100 by extracting pixels from image 112.

FIG. 1C schematically shows the extension of an image n using motion vectors vₐⁱ and vₘⁱ, i=1 or 2 and surrounding images n−2, n−1 and n+1. The basic steps are as follows:

Start adding at the pixels closest to the border, e.g. 116 or 124.

Get a motion vector vₐⁱ for the current pixel xₐⁱ. This means determining a motion vector vₐⁱ for a position outside the image n, which is possible because the motion vector vₐⁱ is based on an existing motion vector vₘⁱ which is located inside image n. Optionally a more complex motion model is used to determine the motion vector vₐⁱ.

Fetch the pixel value for that pixel x_{c}ⁱ in a previous n−2, n−1 or next n+1 image. This value can be obtained from one of the surrounding images, at the “compensated” pixel position v_{c}ⁱ=xₐ+kvₐⁱ, where x_{c}ⁱ is the compensated pixel position, xₐⁱ the position in the side portion to be added, vₐⁱ the motion vector valid at xₐⁱ, and k the time difference, i.e. the number of image periods between the image n and the “source” image (k=. . . −2,−1,1,2, . . .). The image that should act as the “source”, is the image nearest in time to the image n for which x_{c}ⁱ is located inside the image borders, e.g. 118 or 122. This is the nearest time that the information to be added is found in an image. Hence image n−2 for border 122 and image n+1 for border 118.

To get a pixel value from position x_{c}ⁱ, interpolation between pixels could be necessary if xₐⁱ is non-integer. In some cases where x_{c}ⁱ is just outside the image, the nearest pixel inside the border can be used to get a pixel value corresponding to position x_{c}ⁱ. If applicable, the pixel value is retrieved from more than one position x_{c}ⁱ: more than one image, multiple values for k. Pixels values from these multiple images are then combined by using an average or median operator to increase the robustness.

This process is continued for as many pixels outside the image borders, e.g. 116 or 124, as possible. The adding stops when the reliability as indicated by the reliability unit 226 drops below a predetermined threshold. See FIG. 2E.

FIG. 2A schematically shows an embodiment of an image processing unit 200 according to the invention comprising:

a motion estimation unit 204 for estimating a first set 210 of motion vectors of pixels corresponding to a first portion of a scene 105 which is visible in the first image 110 and the second image 108;

a motion extrapolation unit 206 for estimating a second set 212 of motion vectors of pixels corresponding to a second portion 103 of the scene 100 which is visible in the second image 108, but invisible in the first image 110, based on the first set of motion vectors 210; and

an extension unit 208 for extending the first image 110 at a side of the first image with pixels of the second image 108 based on the second set of motion vectors 212. On the input connector 214 of the image processing unit a sequence of mages is provided. The images have a predefined aspect ratio. These images are temporarily stored in the memory device 202. After extension of the first image by the extension unit 208, the resulting extended image is provided at the output connector 216.

FIG. 2B schematically shows an embodiment of an image processing unit 201 according to the invention comprising a motion model unit 218. The first set of motion vectors 210 is provided to the motion model unit 218 which determines a motion model describing global changes between the first image 110 and the second image 108. The motion model is input for the motion extrapolation unit 206. The motion model can comprise parameters related to global changes between the first image 110 and the second image 108 that are caused by panning of a camera capturing the scene 100 or that are caused by changed zoom of the camera capturing the scene 100. Hence the parameters are e.g. pan speed, pan direction and zoom speed.

FIG. 2C schematically shows an embodiment of an image processing unit 203 according to the invention comprising an enlargement unit 222. The enlargement unit 222 is cascaded with the extension unit 208. The extension unit 208 provides an extended image 114 to the enlargement unit 222, which is arranged to stretch the extended image 114 resulting in an enlarged image 306 which is provided to the output connector 220 of the image processing unit. The enlarged image 306 has an aspect ratio substantially equal to a value of an element of the set of standard aspect ratios being used in television. The enlargement unit 222 is arranged to set the center of the enlarged image 306 substantially equal to the center of the first image 110. The pixel extension can be performed asymmetrically by adding more pixels at one side than at the other. This could cause the center of the enlarged image 306 to move out of the center of the first image 110, if the enlargement unit 222 was not aware of this. Therefore it is preferred that the enlargement unit 222 takes this asymmetry into account, e.g. by performing an asymmetric non-uniform zoom. See also FIG. 4 for the non-uniform zoom.

FIG. 2D schematically shows an embodiment of an image processing unit 205 according to the invention comprising a reliability unit 226 which is arranged to control the extension unit 208 based on the first set of motion vectors 210. The extension unit 210 has to add as many pixels as possible without generating annoying artifacts. It is preferred that the number of added pixels does not change much between successive images, because this can result in very visible and annoying jitter: switching between extension by the extension unit 208 and zoom by the enlargement unit 222. Therefore, some temporal “smoothing” of the size of the added portion is performed by the extension unit 208. It can however be expected that, in practice, a pan of the image will be consistent over time. If there is any abrupt change in camera motion, this will probably be a scene change. In this case the number of added pixels can be allowed to change abruptly. Nevertheless, any sudden changes are prevented.

When the reliability is low, the possible artifacts are reduced by some form of post-processing performed by the extension unit 208. This post-processing can be e.g. blurring the image, or with a gradual fade between original and added portions by also calculating “added’ pixels for some area inside the first image. Optionally this fading can also be used for the transition between portions of different images in the added part. The assumption is that some inconspicuous degradation of the image can be tolerated in these side parts, because the viewer does not focus on them, but perceives them with the peripheral view, i.e. to create a sense of being immersed in the action. On the other hand, when it is clear to the viewer that the side parts are added to the extended image by the application of “smart and powerful” digital processing, the artifacts can be tolerated to a higher degree. Especially as long as they are limited to blurring or do not attract attention in any way. Optionally the calculation of added pixels can be continued when the reliability is too low, as long as the post-processing ensures the reliability of the end result. For example, if a few pixels in the edge cannot be calculated, the reliability of the whole vertical line would be low. By calculating the line anyway, and letting the extension unit 208 “fix” the missing pixels, the result can still be sufficient.

FIG. 2E schematically shows an embodiment of an image processing unit 207 according to the invention being arranged to extend images recursively. To overcome problems with limited memory and motion vectors that are extended beyond their validity, a recursive approach is used. This basically means that any image parts added, are stored with the first image. A new first image 228 is created based on the extended image 224. The new first image 228 can now be used in subsequent images as a source of side-information. In doing so, there must be some way to determine when a pixel has “expired”, i.e. when it has been re-used long enough and can no longer be trusted. The simplest way would be to not use the outer edges of the previous recursively extended image, because they were taken from an original longest ago. The recursion only works in the history direction, meaning only the image side that corresponds to previous images can be extended. Nevertheless, it could well be that this asymmetric image expansion is not objectionable at all. Furthermore, the repeated re-using of stored pixels will probably cause some blurring as a result of repeated interpolations, but this may even help in disguising possible artifacts. The stored image can be larger than the resulting enlarged image. This means that, even though the reliability of portions of the stored image is low and hence they are not included in the image that is presented to the enlargement unit, they can be used for calculating later images.

FIG. 3 schematically shows a first image 110, an extended image 114 and an enlarged image 306. The first image 110 is extended with the portions 312 and 310 resulting in extended image 114. The extended image 114 is then linearly zoomed in horizontal direction resulting in images 306. With linearly zoomed is meant that the enlargements of 312 to 313; 110 to 309 and 310 to 311 are substantially mutually equal.

FIG. 4 schematically shows the effect of a non-uniform zoom. The image 402 is horizontally zoomed resulting into image 404. The amount of zoom gradually changes in horizontal direction. The effect is that the width of portion 410 of image 404 is almost three times bigger than the corresponding portion 406 of image 402, whereas the width of portion 412 of image 404 is substantially equal to the corresponding portion 408 of image 402.

FIG. 5 schematically shows an image display apparatus 500 according to the invention comprising:

a receiver 502 for receiving a sequence of images. The images may be broadcasted and received via an antenna or cable but may also come from a storage device like a VCR (Video Cassette Recorder) or DVD (Digital Versatile Disk). The aspect ratio of the images are conform a television standard, e.g. 4:3; 16:9 or 14:9;

an image processing unit 200 implemented as described in connection with FIGS. 2A-2E; and

a display device 504 for displaying images. The type of the display device 504 may be e.g. a CRT, LCD or PDP. The aspect ratio of the display device 504 is conform a television standard: 16:9.

The image processing unit 200 performs an aspect ratio conversion of the images of the received sequence of images if the aspect ratio of these images does not correspond to the aspect ratio of the display device 504. In many cases the aspect ratio conversion is a combination of extension with pixels extracted from other images of the sequence and an enlargement. Other aspect ratio conversion methods can also be applied when they are appropriate. For example in case of a 4:3 “letterbox” input, a combination of vertical and horizontal zoom is performed.

It should be noted that the above-mentioned embodiments illustrate rather than limit the invention and that those skilled in the art will be able to design alternative embodiments without departing from the scope of the appended claims. For example, while described embodiments provide a horizontal extension of 4:3 images to make them fit on a 16:9 screen, the invention may be used for a vertical extension of 16:9 images to make them fit on a 4:3 screen. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image processing unit (200,201,203,205,207) for extending a first image (110) of a sequence of images with pixels resulting in an extended image (114), the sequence comprising the first image (110) and a second image (108), characterized in that the image processing unit (200,201,203,205,207) comprises:
a motion estimation unit (204) for estimating a first set of motion vectors (210) of pixels corresponding to a first portion (105) of a scene (100) which is visible in the first image (110) and the second image (108);
a motion extrapolation unit (206) for estimating a second set of motion vectors (212) of pixels corresponding to a second portion (103) of the scene (100) which is visible in the second image (108), but invisible in the first image (110), based on the first set of motion vectors (210); and
an extension unit (208) for extending the first image (110) at a side of the first image (110) with pixels of the second image (108) based on the second set of motion vectors (212).

2. An image processing unit (200,201,203,205,207) as claimed in claim 1, characterized in that the extension unit (208) is arranged to extend the first image (110) similarly at another side of the first image (110) with pixels of a third image (112).

3. An image processing unit (201,203,205,207) as claimed in claim 1, characterized by further comprising a motion model unit (218) for generating a motion model describing global changes between the first image (110) and the second image (108), the motion model being based on the first set of motion vectors (210), and being input for the motion extrapolation unit (206).

4. An image processing unit (201,203,205,207) as claimed in claim 3, characterized in that the motion model comprises parameters related to global changes between the first image (110) and the second image (108) that are caused by panning of a camera capturing the scene (100).

5. An image processing unit (201,203,205,207) as claimed in claim 3, characterized in that the motion model comprises parameters related to global changes between the first image (110) and the second image (108) that are caused by changed zoom of the camera capturing the scene (100).

6. An image processing unit (203,205,207) as claimed in claim 1, characterized by further comprising an enlargement unit (222) to enlarge the extended image (114) to an enlarged image (306) with a predefined aspect ratio.

7. An image processing unit (203,205,207) as claimed in claim 6, characterized in that the enlargement unit (222) is arranged to perform a non-uniform zoom.

8. An image processing unit (203,205,207) as claimed in claim 6, characterized in that the enlargement unit (222) is arranged to set the center of the enlarged image (306) substantially equal to the center of the first image (110).

9. An image processing unit (205,207) as claimed in claim 1, characterized in comprising a reliability unit (226) to control the extension unit (208) based on a reliability of the first set of motion vectors (210).

10. An image processing unit (200,201,203,205,207) as claimed in claim 1, characterized in that the extension unit (208) is arranged to extend the first image (110) with pixels of a fourth image which is also extended in a similar way.

11. A method of extending a first image (110) of a sequence of images with pixels resulting in an extended image (114), the sequence comprising the first image (110) and a second image (108), characterized in comprising the steps of:
estimating a first set of motion vectors (210) of pixels corresponding to a first portion (105) of a scene (100) which is visible in the first image (110) and the second image (108);
estimating a second set of motion vectors (212) of pixels corresponding to a second portion (103) of the scene (100) which is visible in the second image (108), but invisible in the first image (110), based on the first set of motion vectors (210); and
extending the first image (110) at a side of the first image (110) with pixels of the second image (108) based on the second set of motion vectors (212).

12. An image display apparatus (500) comprising:
a receiver (502) for receiving a sequence of images;
an image processing unit (200,201,203,205,207) as claimed in claim 1 for extending a first image (110) of the sequence of images resulting in an extended image (114); and
a display device (540) for displaying the extended image (114).
